(19) United States
(12) Patent Application Publication
(10) Pub. No.: US 2008/0190958 A1
(43) Pub. Date: Aug. 14, 2008

(54) CONTAINER HAVING A SECONDARY RESERVOIR FOR METERED DOSING OF ADDITIVES

(75) Inventors: Daniel M. Wyner, North Scituate, RI (US); Roger J. LaFlamme, Enfield, CT (US); Robert J. Mileti, Torrington, CT (US)

Correspondence Address: BARLOW, JOSEPHS & HOLMES, LTD., 101 DYER STREET, 5TH FLOOR, PROVIDENCE, RI, 02903, US

(73) Assignee: Poly-D, LLC, Torrington, RI (US)

(21) Appl. No.: 12/028,181

(22) Filed: Feb. 8, 2008

Related U.S. Application Data
(60) Provisional application No. 60/889,582, filed on Feb. 13, 2007.

(51) Int. Cl. B67D 5/52; B65D 37/00

(52) U.S. Cl. 222/135; 222/207

(57) ABSTRACT

A fluid container is provided that includes at least two separate reservoirs therein and a metering pump device for delivering a substantially equal metered dose of fluid material from one of the reservoirs to the other reservoir with each dispensing operation. In one example, a beverage container is provided that allows the user to introduce a metered dose of ingredients or additives from a separate reservoir to the beverage contained therein prior to or while drinking. In another example, a cap is provided that can be affixed to a beverage container, wherein the cap contains ingredients or additives and a metered dispensing system. The container or cap allows the user to add or adjust the levels of flavorings, supplements, purifying agents, or other ingredients prior to or during drinking.

### CROSS-REFERENCE TO RELATED APPLICATIONS

This application is related to and claims priority from earlier filed U.S. Provisional Patent Application No. 60/889,582 filed Feb. 13, 2007.

### BACKGROUND OF THE INVENTION

The present invention relates generally to product packaging and/or containers that include integrated dispensing devices. More specifically, the present invention relates to a dual reservoir fluid container that allows the user to introduce a metered dose of ingredients or additives to the primary fluid contained therein prior to or during use.

Various types of fluid material and media are employed for different purposes throughout commerce and industry. For example, there are various products in the areas of personal care, home care, air care, transportation care and food industries that require a fluid material to be dispensed in some manner from a source of such material. Further, when this material is sold in commerce, it must be contained and stored in some type of container while awaiting use. Ultimately, when that product is used, it must be dispensed from its storage container to the desired location for use.

In the prior art, there are many different types of dispensers that are employed for the delivery of a stored fluid material to their desired location for use. For example, a storage container having a flexible body with a nozzle tip extending therefrom is commonly provided for such a purpose. An example of such use can be seen in the context of a ketchup dispenser, where a user squeezes the container body to urge the fluid material (ketchup) out from container body and through the nozzle tip to accurately deposit the fluid material at the desired location. In such an application, the amount of fluid that is ultimately delivered is determined by the how much the user actually squeezes the container body. While this method has provided marginally acceptable results, this method also typically yields an erratic fluid volume since more or less fluid material may be delivered on each successive squeeze of the container body. Also, the container must be held upright to avoid leakage because no valves are employed in the fluid nozzle tip.

In another example of a prior art dispensing device, a flexible container is provided that holds a volume of fluid material to be delivered. In an attempt to overcome the leakage issue noted above, a single one-way check valve is provided at the exit port of the flexible container. When the flexible body is squeezed, the material is urged out under pressure through the valve. The difficulty here is that the valve over time becomes partially clogged thereby requiring that the user apply additional pressure to cause the valve to open. As a result, once the valve opens, the additional pressure causes more fluid material to be deposited than the user typically would have desired.

In addition to the above noted need for simply dispensing a volume of fluid material onto an available surface, or in the case of a condiment onto a food item, there are currently in the marketplace a wide variety of consumer beverages that are differentiated by the inclusion or exclusion of specific ingredients or flavorings. For example, in the area of beverages, sports drinks and flavored waters, many times the same beverage will be offered both with and without a dose of caffeine. Other examples include drinks that are differentiated based upon the type of sweetener or artificial sweetener employed therein, often denoting a diet verses a standard beverage. Still further, there are beverages that are formulated to contain specific vitamin supplements or other nutrients that are specifically tailored for athletic activity or other health benefits.

Generally, in the prior art, in order to have the benefit of either a caffeinated or non-caffeinated beverage or a sweetened versus non-sweetened beverage, the user had to purchase two separate containers that each contained a version of the beverage that the consumer desired. Similarly, in the context of flavored waters, some consumers may desire the water to be highly or intensely flavored while others may prefer less flavor intensity. In this regard there is a need for a product that allows a user to selectively adjust the use of additives such as sweeteners, flavorings, caffeine, vitamins and the like based on their current need or particular tastes.

While in the prior art, the concept of dual chambered beverage or food containers is not novel, the user typically had little control over the amount or rate at which the material in the two chambers was combined. In other words, in the prior art it is typically an all or nothing proposition when mixing the contents of the two chambers. In other words, the previously available prior art devices are incapable of delivering a substantially equal dose of fluid with each operation because they simply open up the container body and permit the combination of the two fluids that were previously maintained separately in the two chambers. In this context, such a lack of control is highly undesirable when a user is attempting to controllably dose caffeine or vitamins into a beverage for consumption.

In view of the foregoing, there is need for a device that eliminates a user's need to carry two different beverage containers in order to have both a dosed and un-dosed version of the beverage contained therein. Further, there is a need to eliminate dual chambered beverage containers of the prior art that suffer from various disadvantages that make them difficult and awkward to use. Further, these prior art dispensers often provide a user with unexpected results. Therefore, there is a need for a fluid container that provides a selective dosing mechanism that is easy to operate. There is a further need for a accessory fluid dispenser that operates in connection with a primary fluid reservoir that is capable of delivering a metered dose of the accessory fluid with each dispensing operation in order to produce predictable flow and a better control of the accessory fluid material application. Many of these needs are met by commonly owned, co-pending U.S. patent application Ser. No. 11/074,817, filed on Mar. 8, 2005 and U.S. patent application Ser. No. 11/951,351, filed on Dec. 6, 2007, which are incorporated herein by reference. This application sets forth a device for dispensing accessory liquids from an accessory reservoir in a metered fashion into a primary fluid that is contained in a primary fluid container.

### BRIEF SUMMARY OF THE INVENTION

In this regard, the present invention preserves the advantages of prior art metering dispensing devices and dual chambered fluid containers. In addition, the present invention provides new advantages not found in currently available devices and overcomes many disadvantages of such currently available devices. The present invention is generally directed to a novel and unique fluid container that has at least two separate reservoirs therein and a metering pump device for delivering a substantially equal metered dose of fluid material from one of the reservoirs to the other reservoir with each dispensing operation. In one example, the present invention relates to a beverage container that allows the user to introduce a metered dose of ingredients or additives from a separate reservoir to the beverage contained therein prior to or while drinking. In another embodiment, the invention relates to a cap that can be affixed to a beverage container wherein the cap contains ingredients or additives and a metered dispensing system. The container or cap allows the user to add or adjust the levels of flavorings, supplements, purifying agents, or other ingredients prior to or during drinking. Still further, the present invention may be in the form of a ring that includes an accessory reservoir and a metered dispensing pump that is installed around the neck of a primary fluid reservoir to allow dispensing of the accessory fluid therein.

Generally, the present invention allows for the accessory fluid or ingredients to be added to the primary container on an interactive basis on the part of the consumer. Thus, a bike rider for example can purchase a sports drink for a long ride and have the option of adding caffeine at various dosage levels or not adding caffeine at all depending upon their feeling and performance in a ride. In other instances, the user can meter the amount of other nutrients or supplements or flavorings into the beverage on an interactive basis. In still other cases, the present invention could allow the use of ingredients that would spoil, degrade in taste, or otherwise lose potency or effect if exposed to the beverage or the environment for too long.

The teachings of the present invention may be part of any basic beverage container, which is made out of materials well known to those skilled in the art of making such containers. The invention consists of a primary container, at least one accessory fluid reservoir and at least one metered dosing actuator, which will be affixed to the primary container or molded as part of such a container. The accessory reservoir contains the ingredient or ingredients to be metered and the dosing actuator is designed so as to pump ingredients from the accessory reservoir into the primary container or alternatively the pumping mechanism can be designed as to pump the ingredients directly into the mouth of the consumer by directing them in or around the mouth of the beverage container.

The metering mechanism employed within the present invention is substantially similar to that found in the above noted U.S. patent application Ser. Nos. 11/074,817 and 11/951,351. The accessory reservoir is formed to include an interior fluid storage region therein. A metering housing, having a preferably flexible construction, is disposed in fluid communication with the fluid storage region and a first one-way valve is disposed between the container and the flexible metering housing. When the flexible metering housing is depressed and released a vacuum action generates a one-way flow from the interior fluid storage region of the container that serves to fill the predetermined volume of the chamber within the metering housing. A second valve, in fluid communication with the metering housing output port, permits one-way fluid flow from the metering chamber to the primary container or the mouth of the user when the metering housing is depressed again. Each time the metering housing is depressed a substantially equal volume of fluid is dispensed from the accessory reservoir, while upon release, the metering housing is refilled by drawing fluid from the fluid storage region.

Further, in the context of the present invention, while a beverage container is primarily described, it should be appreciated by one skilled in the art that the present invention is equally applicable for use in connection with any two part fluid system including but not limited to candies, epoxy adhesive materials, hair colorants, other applications including two-component reactive chemicals such as chemical glow sticks. The scope of the invention is directed to the use of a two compartment storage system with a measured dosing pump to transfer material from one reservoir to another in a controlled and measured fashion and is not limited to those materials that are contained therein.

It is therefore an object of the present invention to provide a fluid dispensing device that can transfer a substantially equal volume of fluid additive from an accessory reservoir to a primary storage container with each dispensing operation. It is a further object of the present invention to provide a metered fluid dispensing accessory that can be added to a primary fluid storage container to allow metered dosing of the ingredients contained within the dispensing accessory. It is still a further object of the present invention is to provide a fluid dispensing accessory device that can deliver a metered dose of the fluid from within the accessory device at any point from the device.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a perspective view of a dual reservoir dispensing device of the present invention;

FIG. 2 is a cross sectional view of the dispensing device of the present invention taken along line 2-2 of FIG. 1;

FIG. 3 is a perspective view of a first alternate embodiment dual reservoir dispensing device of the present invention;

FIG. 4 is a perspective view of a second alternate embodiment dual reservoir dispensing device of the present invention;

FIG. 5 is a perspective view of a third alternate embodiment dual reservoir dispensing device of the present invention;

FIG. 6 is a perspective view of a fourth alternate embodiment dual reservoir dispensing device of the present invention;

FIG. 7 is a cross sectional view of an alternate embodiment dispensing pump of the invention;

FIG. 8 is a perspective view of a fifth alternate embodiment dual reservoir dispensing device of the present invention; and

FIG. 9 is a perspective view of a sixth alternate embodiment multi-reservoir dispensing device of the present invention.

### DETAILED DESCRIPTION OF THE INVENTION

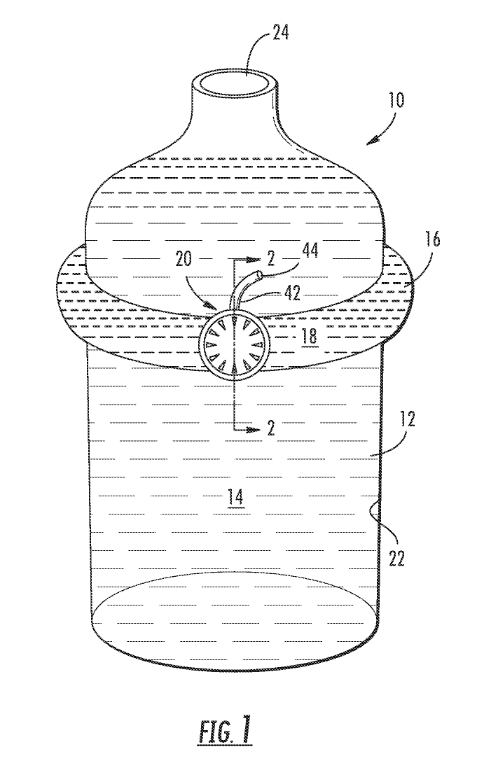

Now referring to the drawings, a first embodiment of the dispensing device of the present invention is shown and generally illustrated at 10 in FIG. 1. As can be seen, the dispensing device 10 of the present invention is generally shown to include a first fluid reservoir 12 containing a first fluid 14, a second fluid reservoir 16 containing a second fluid 18 and a metered dosing pump 20 that is operable to transfer a portion of the second fluid 18 from the second fluid reservoir 16 to the first fluid reservoir 12. In the context of the present invention, this arrangement is suitable for use in connection with any application that requires two different fluids be stored separately prior to their use by the consumer, as in the case for example of, two-part epoxy adhesives, hair colorant or for ingredients that would spoil, degrade in taste, or otherwise lose potency or effect if exposed to the first fluid or the environment for too long a period of time. Similarly, the present invention is particularly useful in connection with beverages in a manner that allows the user to customize the flavor or potency of the beverage through the transfer of additives from the second fluid reservoir to the first fluid reservoir via the metering pump. Further, the second fluid may actually be a powder rather than a fluid. Still further, the present invention contemplates the possibility that more than one secondary or accessory fluid reservoirs and metered dosing pumps are employed as will be described in detail below. While specific examples have been provided above, they are meant for illustration and are not intended to be limiting on the scope of the present invention.

As can best be seen in FIG. 1, the first fluid reservoir 12 is shown roughly as a beverage container that has an outer wall 22 that forms an interior cavity that serves as the first fluid reservoir 12. The first fluid reservoir 12 can be seen to include an opening 24 therein through which the first fluid 14 contained therein can be consumed, either by drinking in the case of a beverage, or by application in the case of other materials. Further, the second fluid reservoir 16 can be seen to encircle an outer surface of the first fluid reservoir 12. The second fluid reservoir 16 serves to contain a second fluid 18 in the form of an additive or ingredient that is to be added to the first fluid 14. The metering pump 20 can be seen positioned between the second fluid reservoir 16 and the first fluid reservoir 12 such that a metered dose of second fluid 18 is deposited directly into the first fluid reservoir 12 and the first fluid 14 contained therein.

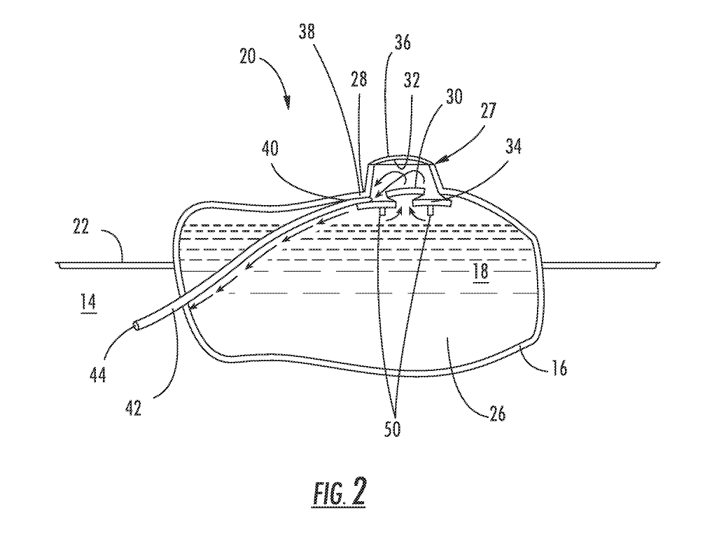

Turning now to FIG. 2, a cross-sectional view through the metering pump 20 along the line 2-2 of FIG. 1 is shown to illustrate the internal construction of the metering pump 12 used in connection with the fluid dispenser 10 of the present invention. The second fluid reservoir 16 is provided to include fluid storage region 26 that contains a volume of second fluid material 18 therein. The outer wall of the second fluid reservoir 16 is preferably made of a flexible material, such as plastic or nylon. Thus, as fluid material 18 is evacuated from within the second fluid reservoir 16, it will collapses gradually for a compact structure.

A metering housing 27 is provided at a first opening 28 in the second fluid reservoir 16. The metering housing 27 includes an intake one-way valve 30, such as a check valve, to pull fluid 18 from the fluid storage region 26 of the second fluid reservoir 16 into a metering chamber 32 of a predetermined size. Any type of valve can be used to suit the given application. The intake valve 30 is positioned in a base plate 34 of the metering housing 27. Thus, fluid 18 can only flow in one way from the fluid storage region 26 into the metering chamber 32. The metering chamber 32 is defined by a flexible membrane 36 in the form of a button or bulb that is accessible and manipulatable on the exterior surface of the second fluid reservoir 16. The button 36 is preferably clear to provide an indicator to the consumer when the metered dosage of fluid material 18 is ready for delivery.

An output valve 40 is provided in fluid communication with the metering chamber 32 of the metering housing 26. Thus, the fluid residing in the metering chamber can only exit through the output valve 40. Also, a fluid conduit 42 is provided to direct the exit of the second fluid 18. In this particular case to the interior of the first fluid reservoir 12. Preferably, as seen in FIG. 2, the fluid conduit 42 connects the output valve 40 of the metering housing 26 to an exit port 44 located on an interior side of the first fluid reservoir 12. This permits the metering housing 27 to be on an opposite side as the side through which the fluid 18 exits. The fluid conduit 42 can be directed and located to exit at any point through the second fluid reservoir 16 depending on the application at hand. Also, the output valve 40 may be located at the exit port 44, as an alternative depending on the requirements of the application.

In accordance with the present invention, each press of the flexible membrane 36 causes a metered amount of second fluid 18 to be forced through the outlet port 44 to provide the desired measured dosing application. This button/membrane 36 can be placed anywhere on the device, as needed. Still referring to FIG. 2, the operation of the metered dosing pump 20 is further explained. The button 36 of the metering housing 27 is depressed to initiate a vacuum operation. More specifically, when the button 36 is further released, second fluid 18 is pulled from the second fluid reservoir 16 into the metering chamber 32 which is configured to be of a certain known volume. The act of releasing the button 36 fills the metering chamber 32 to substantial capacity. Thus, a metered amount of second fluid material 18 is contained within the metering chamber 32 in preparation for delivery. The size of the metering chamber 32 can be selected according to the type of second fluid material 18 to be dispensed, the application therefor and the desired dosage volume. A further depression of the button 36 urges the measured volume of second fluid 18 within the metering chamber 32 to exit out through the output valve 40 of the metering housing 27. This known amount of second fluid material 18 is then routed into the first fluid reservoir 12. This allows in most cases for the second fluid 18 to be deposited into the first fluid 14 within the first fluid reservoir 12 to allow the second fluid 18 to mix with the first fluid 14. In the case of a beverage for example, flavorings or other additives in the form of a second fluid 18 are deposited directly into the first fluid reservoir 12 containing a first fluid 14 in the form of a beverage, to allow for the additive to be mixed with the remainder of the beverage. Further, the second fluid 18 may be dispensed in a powder form into the first fluid 14. This would especially be true if the supplementary ingredients have an unpleasant taste or odor, or if these ingredients are flavorings that are designed to flavor the entire beverage.

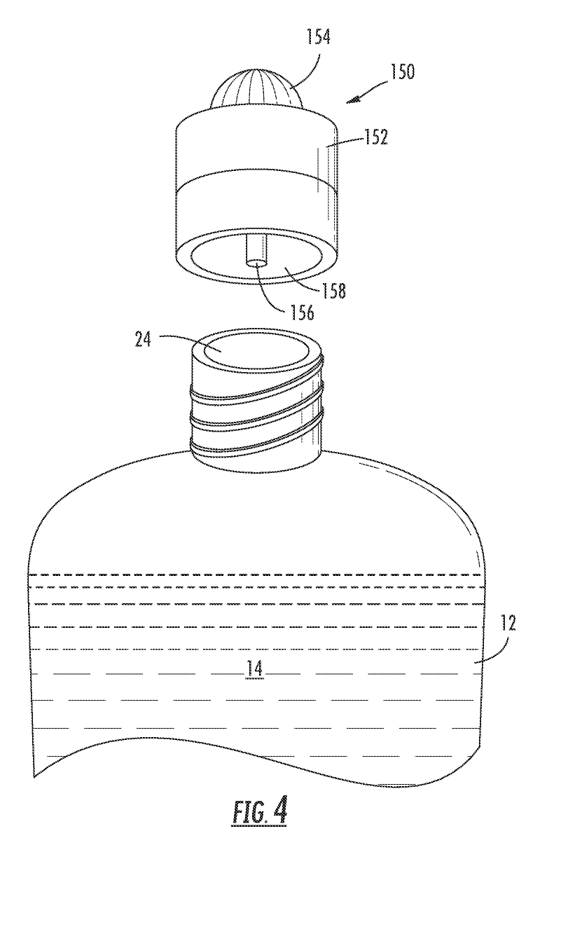

It can also be seen in FIG. 2 that a number of standoff legs 50 emanate downwardly from the base plate 34 of the metering housing 27. These legs 50 prevent the base plate 34 from completely bottoming out against the second fluid reservoir 16 wall thereby blocking flow of second fluid material 18 into the intake valve 30. The standoff legs 50 are particularly useful when the volume of second fluid material 18 left in the second fluid reservoir 16 is running low and the second fluid reservoir 16 is becoming relative flat in configuration. In this situation, there is a possibility that the aforesaid bottoming out may occur. However, the use of the standoff legs 50 of FIG. 4 prevents this from occurring. It should also be appreciated that while standoff legs 50 are shown, other spring biased or spring like structures may be used to accomplish the same function and should be considered interchangeable with the standoff legs 50.

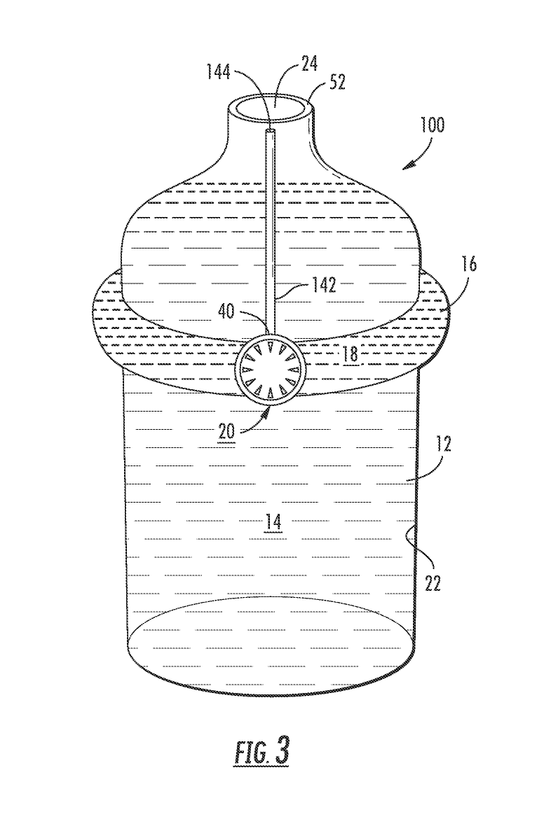

Turning now to FIG. 3, an alternate embodiment 100 of the present invention is depicted. In all respects the construction and operation of the device is the same as described above except that this embodiment includes a fluid conduit 142 that extends from the output port 40 of the metering pump 20. This fluid conduit 142 can be positioned within or on the surface of the outer wall 22 of the first fluid reservoir 12. The fluid conduit 142 serves to direct the second fluid 18 being dosed by the metering pump 20 upwardly to an exit port 144 at the outlet 24 of the first fluid reservoir 12. In this embodiment, the second fluid 18 is either deposited onto the rim 52 of the first fluid reservoir 12, directly into the mouth of a user consuming the first fluid 14 or onto a surface wherein the first fluid 14 and second fluid 18 are to be deposited.

Further, it is possible for the second fluid reservoir 16 to be affixed to the outside of the first fluid reservoir 12, or as shown at FIG. 4 built into a cap structure 150. In this embodiment, the second fluid reservoir 152 is shown built into a cap structure 150 having a metering pump 154 constructed thereon. The metering pump 154 operates as described above and includes an outlet port 156 that can direct the output of second fluid 18 into the first fluid reservoir 12, into the mouth of a user or onto any other surface desired by the user. Further the cap 150 is formed to include engaging means 158 that serve to engage the opening 24 in the first fluid reservoir 12. In this embodiment where the second fluid reservoir 152 and metering pump 154 are built into the cap 150, the cap 150 could either be sold attached to the first fluid reservoir 12, or it is also possible that the cap 150 could be sold separately and later affixed to the first fluid reservoir 12 by the user. For instance, the user could purchase a standard beverage, and then select from a variety of caps 150 each containing different second fluids 18 in the form of additives or collections of additives. If the user wanted to add caffeine to a sports drink, for example, they could purchase a caffeine cap 150 separately.

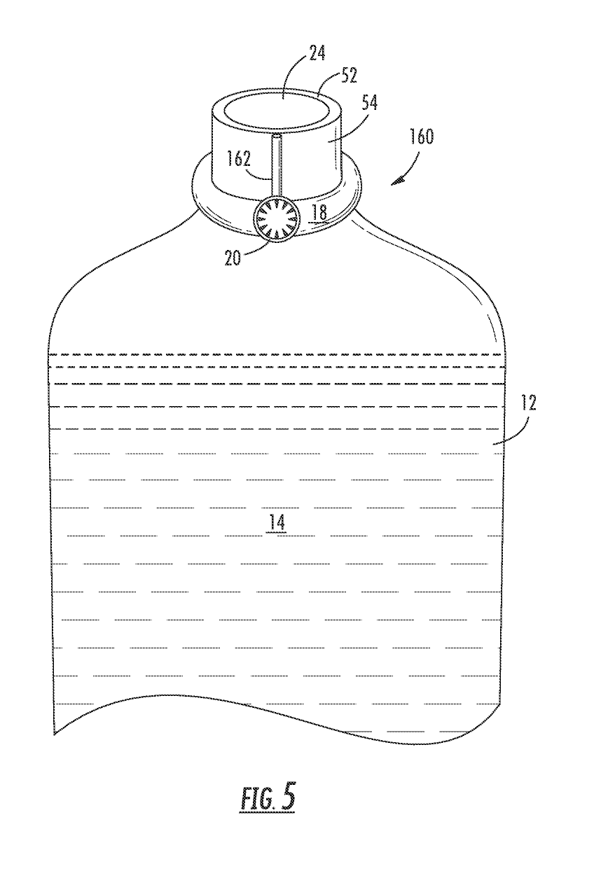

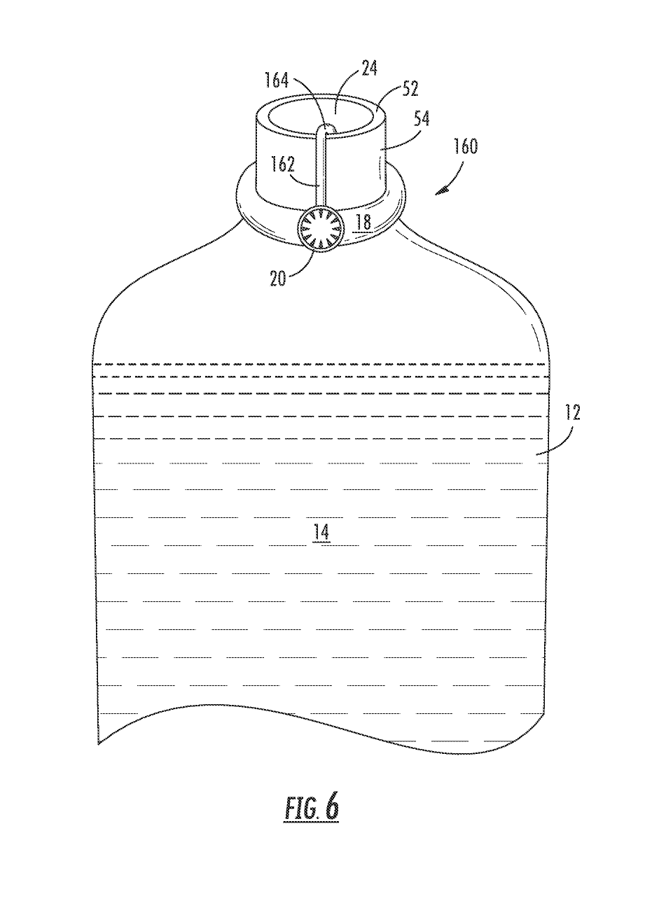

In yet other embodiments as depicted in FIGS. 5 and 6, the second fluid reservoir 160 could be built into any form that could be affixed to the first fluid reservoir 12 as a retrofit. As an example, the second fluid reservoir 160 could be in a ring form to encircle a neck 54 of the first fluid reservoir 12, or could be built into a strip that attaches along one side. The second fluid reservoir 160 could be integrated into the molded shape of the first fluid reservoir 12, or could be external to the first fluid reservoir 12. The second fluid reservoir 160 could also be constructed so as to fit into a molded recess on the first fluid reservoir 12. As shown in FIG. 5, the second fluid reservoir 160 includes a fluid conduit 162 to deposit the second fluid 18 adjacent a rim 52 of the opening 24 in the first fluid reservoir 12 but may alternately include a bend 164 in the end of the fluid conduit 162 that deposits the second fluid 18 into the first fluid reservoir 12 as depicted at FIG. 6. In still another embodiment, the second fluid reservoir 160 and metering pump 20 could be designed to pierce the first fluid reservoir 12 and form a seal thereto.

While the above embodiments and descriptions describe particular locations or depictions of the second fluid reservoir and the metering pump, the invention is not limited to any particular location or second fluid reservoir design or pumping methodology. Also, in addition to supplements and flavorings, the invention could also be used for dosing medicines or for introducing other treatments or ingredients such as those used for the purification of water. An example would be a camping canteen bottle wherein the second fluid reservoir contains a purification chemical that can be used to treat water. The camper could fill the canteen from a water source and then press the dosing pump button one or more times as prescribed to introduce the appropriate amount of chemical to purify that volume of water. In such a case, as in the case of caffeine or other supplements, a specified amount of chemical would be introduced with each press of the button. The user would determine the amount of purification chemical needed and press the pump button one or multiple times.

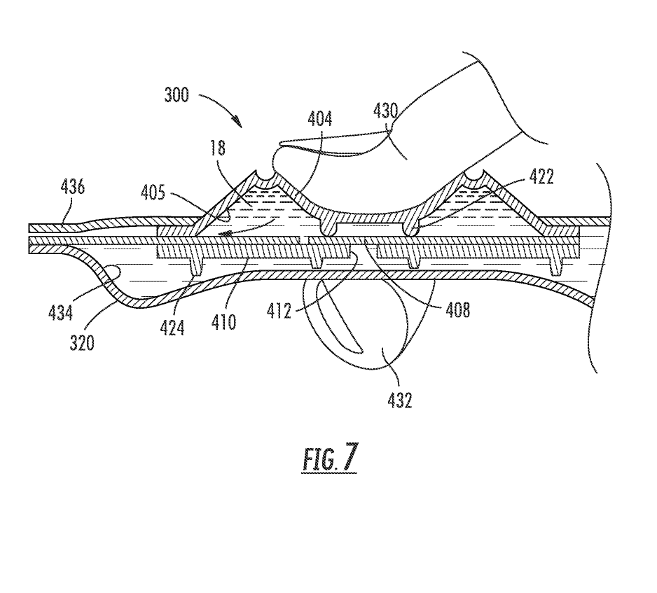

Turning now to FIG. 7, details are shown of an alternate metering pump 300 that includes the improved valving of the present invention that prevents inadvertent or accidental dispensing of second fluid 18 even when pressure is placed on the pump 300 or second fluid reservoir 320. In this embodiment of the pump 300 of the present invention, the base plate 410, through which the flow through aperture 412 passes, is preferably slightly convex, although it may be flat, if desired. Resting above the aperture 412 and within the cavity 405 of the dome is a flapper valve 408 of preferably thin film construction. It is possible that this flapper valve 408 be configured of a normally open condition but also may be configured to lie flat when at rest. As long as the plate 410 with the aperture remains convex, the flapper valve 408 does not seal against the aperture 412 such that any inadvertent contact with the flexible dome pump housing 404 does not result in the dispensing of the product. Instead, since the flapper valve 408 is open, liquid product residing inside the cavity 405 of the flexible pump housing 404 will tend to simply flow back through the inlet aperture 412 to the reservoir within the storage container itself, as indicated by the arrow, rather than flow undesirably out through the exit valve to outside of the pump 300. In use, if a person has the fluid dispenser in their pocket or purse and pressure is accidentally or unintentionally placed on the flexible housing 404 of the pump 300, liquid will not flow outside the dispenser thereby preventing a mess from being made due to unintentionally dispensed product.

FIG. 7 illustrates intentional dispensing of second fluid 18. When it is desired to actually dispense the liquid product 18, the user's thumb 430 can depress the flexible dome 404 and the user's index finger 432 can invert the base plate 410 from convex to concave, by application of force against the stand-off legs 424, such that flexible dome 404, with the assistance of the stand-off legs 422 under the flexible dome, securely seals and provides a positive lock of the flapper valve 408 over and about the aperture 412 thereby closing the liquid flow passage back into the reservoir 434 of the second fluid reservoir 320. It is also possible that the base plate 410 is concave and then is inverted to a convex configuration. Other fingers of the user may be used to carry out this operation. Thus, the only path for the liquid 302 contained within the cavity 405 of dome 404 is to exit through the one-way outlet valve 436 for intended dispensing of the product, as indicated by the arrows.

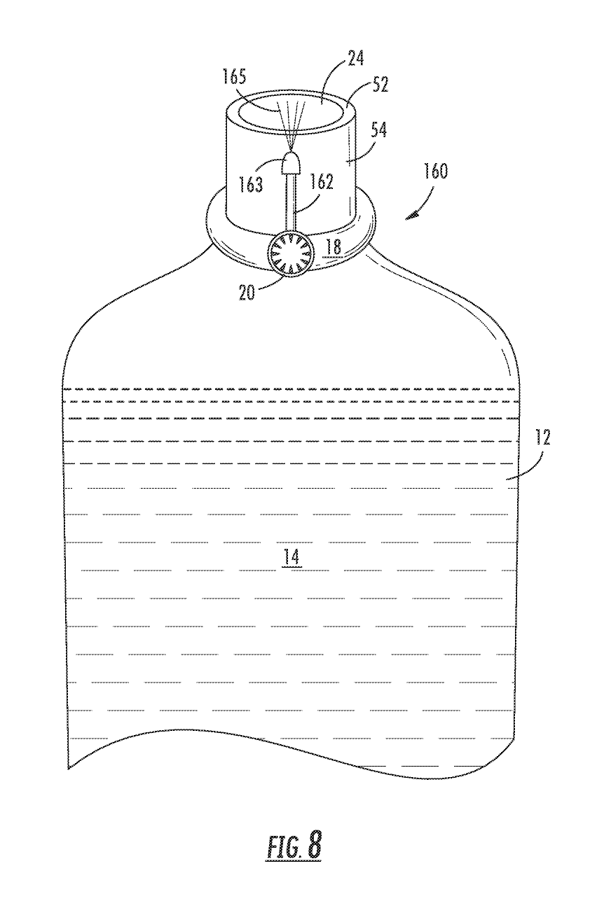

In still another embodiment depicted at FIG. 8, the second fluid reservoir 160 includes a fluid conduit 162 to deposit the second fluid 18 adjacent a rim 52 of the opening 24 in the first fluid reservoir 12. Further, the fluid conduit 162 can be seen to include a spray nozzle 163 on the end of the fluid conduit 162 that dispenses the second fluid 18 in a spray or atomized form at a point adjacent the rim 52 of the device.

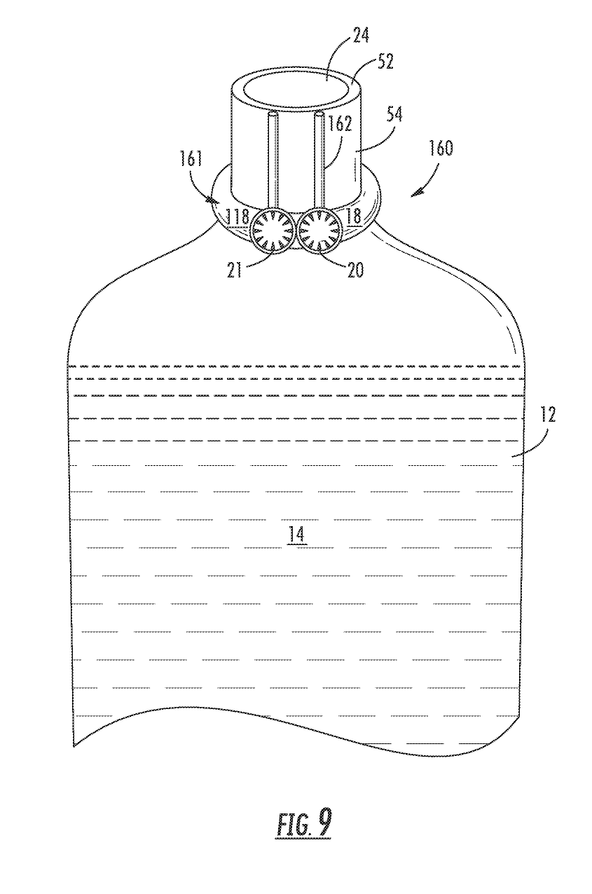

Turning to FIG. 9, another alternative embodiment of the present invention is depicted and can be seen to include more than one second fluid reservoirs. Specifically, the device includes a second fluid reservoir 160 and a third fluid reservoir 161. Each of the reservoirs 160, 161 may contain the same fluid or may contain a second fluid 18 and a third fluid 118. In addition, a single metered dosing pump 20 may be used to dispense the second fluid 18 and third fluid 118 simultaneously or a second metered dosing pump 21 may be provided to allow the second fluid 18 and third fluid 118 to be dispensed separately. Further, this arrangement could be built into any form that could be affixed to the first fluid reservoir 12 as a retrofit or integrated as taught above.

It should be understood that the stand-off legs 422 on the bottom of the flexible dome housing 404 and the stand-off legs 424 on the bottom of the base plate 410 can be modified in size, length and configuration to adjust the amount of squeezing necessary by the user's fingers 430, 432 to effectuate sealing of the flapper valve 408. For example, preferably four standoff legs 422 are provided on the bottom of the flexible dome housing 404 in a 2×2 array and can be 1/32 of an inch in length. It is also possible that these standoff legs 422 can be a single downwardly depending wall, such as in the shape of a circle or square. Such an array is configured to downwardly press against the one-way flapper valve 408 outside of the diameter of the aperture 412 through the base plate 410 to provide a good seal of the flapper valve 408 to the base plate 410.

In application, the dispensing device 10 of the present invention, the size and construction of the metering housing 27 as well as the positioning of where the second fluid material 18 is delivered to the surface of the device can be easily modified to suit the given application. The materials used for the second fluid reservoir 16 and the metering housing 27, while preferably flexible plastic, can be any suitable material for the application at hand. Also, the second fluid reservoir 16 can be made of a different material than the metering housing 27.

In summary, this invention offers many advantages over the prior art by allowing the user flexibility to introduce ingredients on an interactive basis and to control the amounts of such ingredients. The present invention also allows the ingredients to be added just prior to consuming them, which may prevent spoiling or other degradation in the effectiveness or taste of the ingredients. Another advantage is that the consumer can purchase a single beverage and decide on the supplemental ingredients at the time of use. In the case of the cap containing the dosing device, the user can change caps to provide alternative additives to the beverage.

It would be appreciated by those skilled in the art that various changes and modifications can be made to the illustrated embodiments without departing from the spirit of the present invention. All such modifications and changes are intended to be covered by the appended claims.

What is claimed:

1. A fluid dispensing device, comprising:
a first fluid reservoir containing a first fluid;
at least one second fluid reservoir containing a second fluid;
at least one metered dispensing pump including, a flexible metering housing, having a metering chamber therein with a predetermined volume, disposed in fluid communication with the second fluid reservoir; a first valve disposed between the second fluid reservoir and the flexible metering housing to permit unidirectional fluid flow from the second fluid reservoir into the metering chamber thereby filling the predetermined volume of the metering chamber; the flexible metering housing further including a metering housing output port; and
a second valve, having a second valve output port, in fluid communication with the metering housing output port and permitting unidirectional fluid flow of a volume of fluid substantially equal to the predetermined volume of the metering chamber from the metering chamber via the second valve output port.

2. The fluid dispensing device of claim 1, wherein the second valve output port directs the fluid flow into the first fluid reservoir.

3. The fluid dispensing device of claim 1, wherein the second valve output port directs the fluid flow to a rim of the first fluid reservoir.

4. The fluid dispensing device of claim 1, wherein the second valve output port directs the fluid flow out through a spray nozzle.

5. The fluid dispensing device of claim 1, wherein the second valve output port directs the fluid flow to an outlet tube adjacent a rim of the first fluid reservoir.

6. The fluid dispensing device of claim 1, wherein the second fluid reservoir is integrally formed with the first fluid reservoir.

7. The fluid dispensing device of claim 1, wherein the second fluid reservoir is a ring disposed about an exterior surface of the first fluid reservoir.

8. The fluid dispensing device of claim 1, wherein the second fluid reservoir is ring that is removably placed about an exterior surface of the first fluid reservoir.

9. The fluid dispensing device of claim 1, wherein the second fluid reservoir is formed as a cap that engages an opening in the first fluid reservoir.

10. The fluid dispensing device of claim 1, wherein the first valve and the second valve are one-way check valves.

11. The fluid dispensing device of claim 1, further comprising:
standoff means connected to the metering housing and proximal to the first valve to prevent the first valve from being blocked.

12. A fluid dispensing device for installation about an opening in a first fluid reservoir containing a first fluid, comprising:
at least one second fluid reservoir containing a second fluid;
at least one metered dispensing pump including, a flexible metering housing, having a metering chamber therein with a predetermined volume, disposed in fluid communication with the second fluid reservoir; a first valve disposed between the second fluid reservoir and the flexible metering housing to permit unidirectional fluid flow from the second fluid reservoir into the metering chamber thereby filling the predetermined volume of the metering chamber; the flexible metering housing further including a metering housing output port;
a second valve, having a second valve output port, in fluid communication with the metering housing output port and permitting unidirectional fluid flow of a volume of fluid substantially equal to the predetermined volume of the metering chamber from the metering chamber via the second valve output port.

13. The fluid dispensing device of claim 12, wherein the second valve output port directs the fluid flow through an outlet tube.

14. The fluid dispensing device of claim 12, wherein the second valve output port directs the fluid flow into the first fluid reservoir.

15. The fluid dispensing device of claim 12, wherein the second valve output port directs the fluid flow out through a spray nozzle.

16. The fluid dispensing device of claim 12, wherein the second fluid reservoir is ring that is removably placed about an exterior surface of the first fluid reservoir adjacent the opening in the first fluid reservoir.

17. The fluid dispensing device of claim 12, wherein the second fluid reservoir is formed as a cap that engages the opening in the first fluid reservoir.

18. The fluid dispensing device of claim 12, wherein the first valve and the second valve are one-way check valves.

19. A cap for installation onto an opening in a first fluid reservoir containing a first fluid, comprising:
a second fluid reservoir containing a second fluid and configured to releasably engage the opening in the first fluid reservoir;
a flexible metering housing, having a metering chamber therein with a predetermined volume, disposed in fluid communication with the second fluid reservoir; a first valve disposed between the second fluid reservoir and the flexible metering housing to permit unidirectional fluid flow from the second fluid reservoir into the metering chamber thereby filling the predetermined volume of the metering chamber; the flexible metering housing further including a metering housing output port;
a second valve, having a second valve output port, in fluid communication with the metering housing output port and permitting unidirectional fluid flow of a volume of fluid substantially equal to the predetermined volume of the metering chamber from the metering chamber via the second valve output port.

20. The cap of claim 19, wherein the second valve output port directs the fluid flow into the first fluid reservoir.
